(19) United States
(12) Patent Application Publication
(10) Pub. No.: US 2025/0168509 A1
(43) Pub. Date: May 22, 2025

(54) PROCESSING APPARATUS, PROCESSING METHOD, AND STORAGE MEDIUM

(71) Applicant: CANON KABUSHIKI KAISHA, Tokyo (JP)

(72) Inventor: MASAAKI KOBAYASHI, Tokyo (JP)

(21) Appl. No.: 18/942,228

(22) Filed: Nov. 8, 2024

(30) Foreign Application Priority Data
Nov. 20, 2023 (JP) 2023-196527

(51) Int. Cl. H04N 23/68; G03B 5/06

(52) U.S. Cl. CPC H04N 23/683; G03B 5/06; H04N 23/6812; G03B 2217/005

(57) ABSTRACT

A processing apparatus according to the aspect of the embodiments acquires inertial information from an image acquired at a time of imaging and to which the inertial information is added, and specifies, based on the inertial information, an image in which a blur amount at the time of imaging is less than a threshold.

### BACKGROUND

### Technical Field

The aspect of the embodiments relates to an information processing technique for specifying an image from among a plurality of images.

### Description of the Related Art

In recent years, cameras capable of recording moving images at high resolution, such as 4K and 8K, have become widespread. Images of frames constituting a 4K or 8K moving image have sufficient resolution, so that the images can also be used as still images. However, among the images of frames of a moving image, there may be an image in which a subject to be imaged is defocused. A defocused state of the image of the subject to be imaged is caused by a motion blur of the subject, a motion blur of the camera due to camera shake or camerawork, or an out-of-focus state of the subject.

On the other hand, Japanese Patent Application Laid-Open No. 2013-26937 discusses a technique for analyzing a defocused state of an image for each frame of a moving image and selecting a frame with a small defocus amount based on an analysis result.

### SUMMARY

According to an aspect of the embodiments, a processing apparatus includes an acquisition unit configured to acquire inertial information of an imaging apparatus from an image acquired at a time of imaging and to which the inertial information is added, and a specification unit configured to specify, based on the inertial information, an image in which a blur amount of the imaging apparatus at the time of imaging is less than a threshold.

Further features of the disclosure will become apparent from the following description of exemplary embodiments with reference to the attached drawings.

### BRIEF DESCRIPTION OF THE DRAWINGS

FIGS. 1A and 1B are block diagrams illustrating examples of a configuration of a system including an information processing apparatus.

FIG. 2 is a flowchart of processing of specifying images with a low accumulated blur and displaying the images in tabular form.

FIG. 3 is a flowchart of processing of generating a list of images with a low accumulated blur.

FIG. 4 is a flowchart of processing of specifying a less defocused frame and displaying the less defocused frame in tabular form.

FIG. 5 is a flowchart of processing of generating a list of images based on a less defocus flag.

### DESCRIPTION OF THE EMBODIMENTS

As in Japanese Patent Application Laid-Open No. 2013-26937, in a case where processing for analyzing a defocused state of images of all frames is performed, the processing will take a long time.

In view of this, the present disclosure is directed to making it possible to specify images with small defocus amounts from among a plurality of images without taking a lot of time on the processing.

Hereinafter, exemplary embodiments of the present disclosure will be described with reference to the drawings. The following exemplary embodiments are not intended to limit the present disclosure, and not all combinations of features described in the present exemplary embodiments are necessarily essential to the solution of the present disclosure. The configurations of the exemplary embodiments may be modified or changed as appropriate depending on the specifications of an apparatus to which the present disclosure is applied and various conditions (use conditions, use environment, and the like). In addition, parts of the exemplary embodiments described below may be combined as appropriate. In the following exemplary embodiments, identical components and processes are designated by the same reference numerals in a description.

### <System Configuration Example>

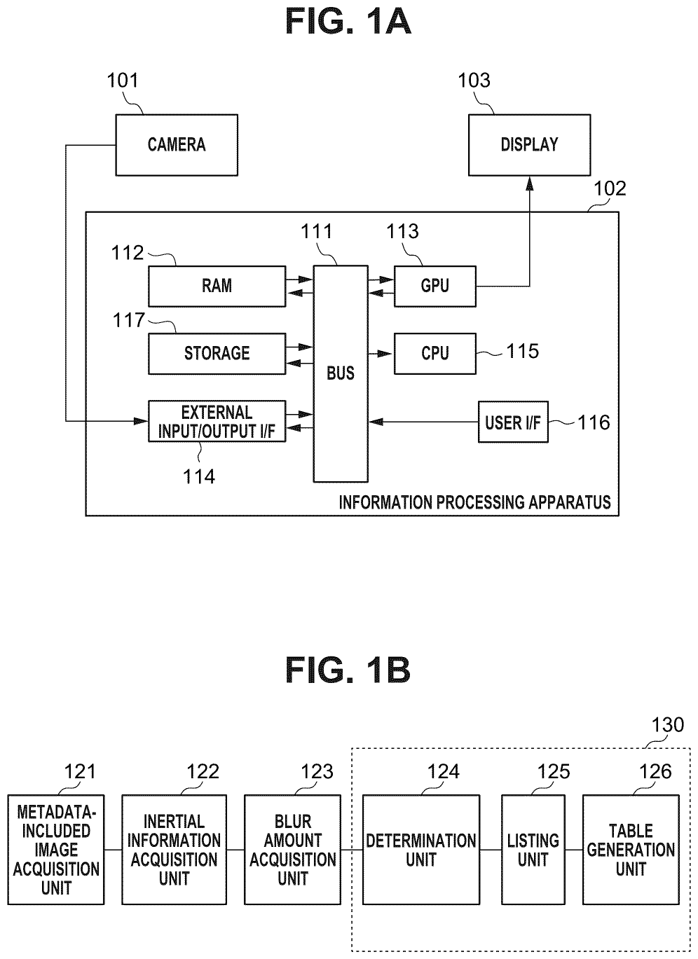

FIG. 1A is a block diagram illustrating an example of a configuration of a system including an information processing apparatus according to a first exemplary embodiment.

As illustrated in FIG. 1A, the system according to the present exemplary embodiment includes, as an example, a camera 101, an information processing apparatus 102, and a display 103. These components are merely examples, and the system may further include other components, such as a communication device for connecting to a printer, a network, and the like.

The camera 101 is an imaging apparatus that is capable of continuously capturing moving images with high resolution, such as 4K and 8K images, and still images with high resolution. The camera 101 also includes an inertial sensor and has a function of adding inertial information detected by the inertial sensor to an image by including the information in metadata. The inertial sensor provided in the camera 101 includes a gyro sensor, an acceleration sensor, and a geomagnetic sensor for detecting a motion of the camera 101 based on geomagnetism. For example, in the case of capturing a moving image, the camera 101 according to the present exemplary embodiment adds inertial information detected by the inertial sensor at the time of capturing each frame of the moving image to an image of each frame. For example, in the case of capturing a still image, the camera 101 adds the inertial information detected by the inertial sensor at the time of capturing the still image to the individual still image. Hereinafter, an image to which the inertial information is added by including the information in metadata is referred to as a metadata-included image. The metadata-included image is then sent to the information processing apparatus 102. In addition to the inertial information, the metadata also includes information related to imaging by the camera 101, such as shutter speed, exposure, and other setting values.

The metadata-included image may be sent from the camera 101 to the information processing apparatus 102 via a wireless or wired communication line, or may be recorded by the camera 101 on a memory card (not illustrated) and then read by the information processing apparatus 102 from the memory card. While the camera 101 can correct camera shake and the like based on the inertial information detected by the inertial sensor, it is assumed that, in the present exemplary embodiment, images on which no blur correction has been performed by the camera 101 and images on which blur correction has been performed to a small extent are sent to the information processing apparatus 102.

The information processing apparatus 102 is a personal computer (PC), for example. In the information processing apparatus 102, a central processing unit (CPU) 115 controls the operation of the entire camera in conjunction with other components based on computer programs, such as an operating system (OS) and application programs. In the example of FIG. 1A, one CPU is provided, but the aspect of the embodiments is not limited to this configuration, and a plurality of CPUs may be provided. In this case, processing can be performed in parallel by multi-thread processing.

The display 103 is a display device that displays a user interface (UI) screen, images of information processing results, and the like.

A graphic processing unit (GPU) 113 is a graphic processor that performs calculation processing required to display an image on the display 103 and outputs the display image to the display 103. Images of the UI screen and information processing results and the like are sent to the display 103 via the GPU 113 and displayed thereon. The GPU 113 is also capable of encoding and decoding images in real time. In the present exemplary embodiment, when image data is encoded, the GPU 113 decodes the encoded image data and converts the image data into an internal image format.

A random access memory (RAM) 112 temporarily stores data that is being processed by the CPU 115 or the GPU 113.

A storage 117 is a large-capacity storage, such as a solid state drive (SSD) and a hard disk drive (HDD), and records data and programs.

A user interface (I/F) 116 is an interface to which a touch panel, a mouse, a keyboard, and the like are integrally connected.

An external input/output I/F 114 is an interface to which a network or a memory card is connected to input and output data.

A bus 111 controls a flow of data in the PC.

Computer programs, such as the OS, application programs, and information processing programs according to the present exemplary embodiment, and various types of data are recorded in the storage 117, and the CPU 115 executes programs loaded from the storage 117 to the RAM 112. The programs and data are input and output among the CPU 115, the RAM 112, and the storage 117 via the bus 111. The image data and the like processed by the CPU 115 or the GPU 113 are recorded on a recording medium, such as a memory card (not illustrated), via the storage 117 or the external input/output I/F 114 and can be shared by other devices and applications.

### <Information Processing>

As described above, the images acquired by the camera 101 are moving images with high resolution, such as 4K or 8K images, and still images with high resolution, so that an image selected from among images of frames of the moving image or from among a plurality of still images is an image with high resolution. The information processing apparatus 102 according to the first exemplary embodiment also has a function of selecting an image from among the images of the frames of the moving image acquired from the camera 101 or from among the plurality of still images.

However, among the images of the frames of the moving image and the plurality of still images captured by the camera 101, there may be an image in which the subject to be imaged is defocused. As described above, a defocused state of the image of the subject to be imaged is caused by a blur due to the motion of the subject, a blur due to the motion of the camera due to camera shake or camerawork, and an out-of-focus state of the subject. The blur caused by the motion of the subject or the motion of the camera is also called a motion blur. The motion blur occurs when a blur due to the motion of the subject and a blur due to the motion of the camera are accumulated within an exposure time. Thus, the motion blur will be called an “accumulated blur” in the following description. In general, at the time of capturing a moving image, images of frames therein are often captured at a slow shutter speed in order to suppress jerkiness. For example, when the frame rate is 30 frames per second (fps), the images of the frames are often captured at a shutter speed of 1/30 seconds. However, the images of the frames captured at the slow shutter speed are prone to the accumulated blur in which the blur of the subject to be imaged, the camera shake, and a blur with directivity in a direction of the camera motion due to camerawork are accumulated within the exposure time.

When selecting an image from among the images of the frames of the moving image acquired from the camera 101 or from among the plurality of still images, the information processing apparatus 102 according to the first exemplary embodiment can specify an image with a low amount of accumulated blur by using the inertial information added to the images by the camera 101. In other words, the information processing apparatus 102 according to the present exemplary embodiment has a function of executing information processing, such as extracting metadata from a plurality of acquired metadata-included images and specifying an image with a low mount of accumulated blur based on the inertial information included in the metadata of each image.

### <Functional Configuration and Information Processing of Information Processing Apparatus>

FIG. 1B is a block diagram illustrating major functional components of the information processing apparatus 102 according to the present exemplary embodiment. The functional components illustrated in FIG. 1B are implemented by executing information processing programs according to the present exemplary embodiment by the CPU 115 of the information processing apparatus 102. A case where a moving image is acquired from the camera 101 is described below as an example.

As illustrated in FIG. 1B, the information processing apparatus 102 includes functional components, namely, an image acquisition unit 121, an inertial information acquisition unit 122, a blur amount acquisition unit 123, and a specification unit 130.

The image acquisition unit 121 acquires a metadata-included image in which metadata including inertial information is added to an image of each frame of the moving image.

The inertial information acquisition unit 122 acquires the inertial information from the metadata-included image acquired by the image acquisition unit 121.

The blur amount acquisition unit 123 acquires information indicating the amount of accumulated blur based on the inertial information acquired by the inertial information acquisition unit 122.

The specification unit 130 specifies an image in which the amount of accumulated blur is less than a predetermined blur threshold from among the frames of the moving image, and generates identification information for identifying the specified image.

The specification unit 130 includes a determination unit 124, a listing unit 125, and a table generation unit 126.

The determination unit 124 determines, for each frame of the moving image, whether the amount of accumulated blur of the image is less than the blur threshold.

The listing unit 125 specifies a frame for which the determination unit 124 has determined that the amount of accumulated blur is less than the blur threshold from among the frames of the moving image, and generates identification information for identifying the specified frame. In the present exemplary embodiment, the listing unit 125 generates, as the identification information, a list of specified frames for which the determination unit 124 has determined that the amount of accumulated blur is less than the blur threshold.

The table generation unit 126 generates a table of images in which the amounts of accumulated blur are less than the threshold, based on the list generated by the listing unit 125.

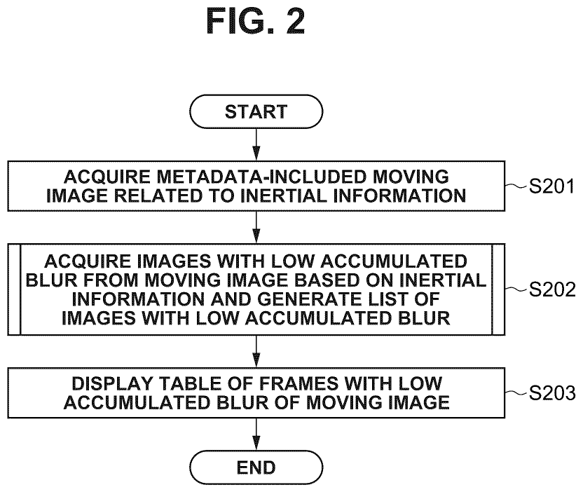

FIG. 2 is a flowchart illustrating a general procedure of information processing in the information processing apparatus 102 according to the present exemplary embodiment, from specifying a frame of a moving image in which the amount of accumulated blur is less than the threshold to displaying such images in tabular form. In the following description, an accumulated blur in an amount less than the blur threshold will be called a low accumulated blur. The information processing in the flowchart illustrated in FIG. 2 is executed by the functional components implemented by the CPU 115 of the information processing apparatus 102 illustrated in FIG. 1B. Unless otherwise described, processing steps (processes) in each flowchart described below are executed in the order indicated by arrows from “Start” to “End”. The frame rate of the moving image is assumed as 30 fps.

First, in step S201, the image acquisition unit 121 acquires a metadata-included image via the external input/output I/F 114, and the inertial information acquisition unit 122 acquires the inertial information included in metadata from the metadata-included image. In the present exemplary embodiment, the inertial information includes information detected by a gyro sensor, information detected by an acceleration sensor, and information detected by a geomagnetic sensor, which are included in the inertial sensor of the camera 101.

In step S202, the blur amount acquisition unit 123 acquires information indicating the amount of accumulated blur of the image of each frame of the moving image, based on the inertial information acquired in step S201.

Further, in step S202, the determination unit 124 of the specification unit 130 determines whether the amount of accumulated blur of the image of each frame of the moving image is less than the predetermined blur threshold. Then, the listing unit 125 specifies frames of the moving image with the low accumulated blur in which the amounts of accumulated blur have been determined as being less than the blur threshold, and generates identification information for identifying the specified frames. In the present exemplary embodiment, the listing unit 125 generates an image list of the identification information for identifying the specified frames. In the present exemplary embodiment, the image list includes frame numbers representing frames that constitute the moving image as elements, and is generated as a list of the frame numbers of the frames determined as having low accumulated blurs. The data structure of the image list is not limited to a list form, and may be a variable length array, for example. Details of the processing from acquiring the amount of blur to generating the image list in step S202 will be described below.

In step S203, the table generation unit 126 generates a table of thumbnail images based on the image list of the frame numbers of the frames with the low accumulated blur generated in step S202. Then, data on the table is sent to the GPU 113, which generates display data of the table and displays the display data on the screen of the display 103. The thumbnail images may be generated by the GPU 113.

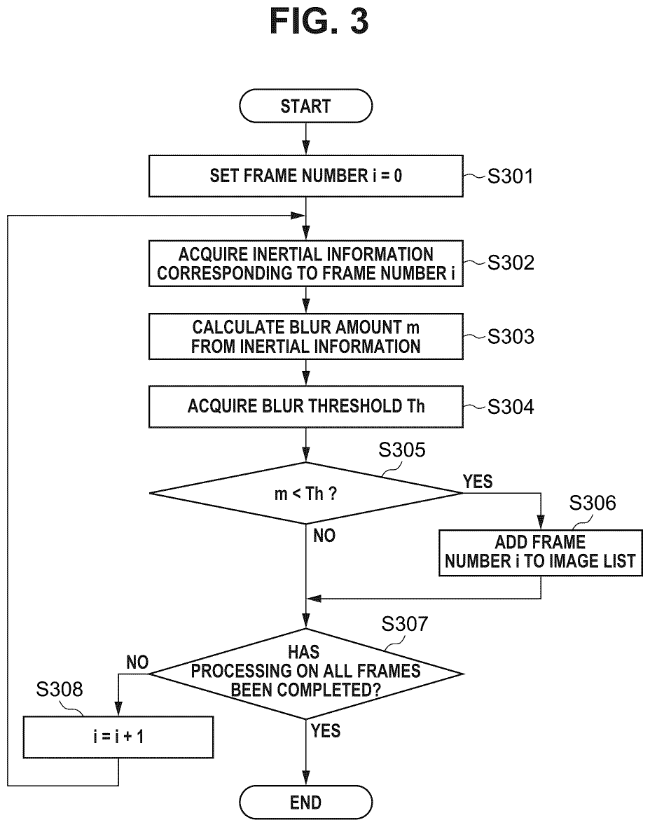

FIG. 3 is a detailed flowchart of the processing from acquiring the amount of blur to generating the image list in step S202 of FIG. 2.

First, in step S301, the blur amount acquisition unit 123 initializes i used as a value indicating a frame number (initializing to i=0).

In step S302, the blur amount acquisition unit 123 acquires inertial information from metadata added to an image of a frame corresponding to the frame number i.

In step S303, the blur amount acquisition unit 123 calculates a blur amount m of the accumulated blur from the inertial information corresponding to the frame number i. In the present exemplary embodiment, the blur amount m is calculated using angular velocity information that is information detected by the gyro sensor included in the inertial information. In the present exemplary embodiment, the angular velocity information from the gyro sensor is constituted of three-axis information for one frame, i.e., three pieces of angular velocity information of pan direction, tilt direction, and roll direction, for example. When the angular velocity component of the pan direction is defined as p, the angular velocity component of the tilt direction is defined as t, and the angular velocity component of the roll direction is defined as r, the blur amount m is expressed by the following formula (1). The unit of the blur amount m is degrees/frame. More specifically, the blur amount m is 30 hertz (Hz) data of the inertial information.

$$m = √ ( {p}^{2} + {t}^{2} + {r}^{2} ) \qquad ( 1 )$$

In step S304, the determination unit 124 acquires a blur threshold Th. In the present exemplary embodiment, the determination unit 124 calculates the blur threshold Th based on shutter speed information included in the metadata added to the frame with the frame number i. When the shutter speed is defined as s, the blur threshold Th is calculated by the following formula (2):

$$Th = k \times s \qquad ( 2 )$$

For example, in the case of acquiring a blur amount of 0.05 degrees or less per frame from a moving image of 30 fps, a coefficient k in the formula (2) is calculated as k=0.05×30=1.5.

Next, in step S305, the determination unit 124 determines whether the blur amount m is less than the blur threshold Th (m>Th). If the blur amount m is less than the blur threshold Th (YES in step S305), the determination unit 124 sets a Boolean variable indicating whether the accumulated blur is the low accumulated blur with a small blur amount to true, and the processing proceeds to step S306. On the other hand, if the blur amount m is equal to or greater than the blur threshold Th (NO in step S305), the determination unit 124 sets the Boolean variable indicating whether the accumulated blur is the low accumulated blur to false, and the processing proceeds to step S307.

If the processing proceeds to step S306, the listing unit 125 adds the frame number i to the image list.

On the other hand, if the processing proceeds to step S307, the listing unit 125 determines whether the processing on all frames is complete. If the processing on all frames has been completed (YES in step S307), the processing in the flowchart in FIG. 2 ends. If the processing on all frames has not been completed yet (NO in step S307), the processing proceeds to step S308.

If the processing proceeds to step S308, the listing unit 125 increments the frame number i to i=i+1, and then the processing returns to step S302. Thereafter, steps S302 to S308 are repeatedly executed until it is determined in step S307 that the processing has been completed.

The number of frames in one moving image sequence may range from several thousand to several tens of thousands, for example. In the present exemplary embodiment, since the process of specifying a frame with the low accumulated blur is performed based on the inertial information acquired by the inertial sensor, a process of analyzing an image is not required, and a frame with a small amount of the accumulated blur can be specified from among the frames of a moving image in a short time. In the present exemplary embodiment, specified images of the frames are displayed as thumbnail images in tabular form, so that the user can select a desirable image of a frame with a small amount of blur. The selected frame may be converted into Joint Photographic Experts Group (JPEG) that is a still image format, for example, and then saved or printed.

In the present exemplary embodiment, the example is used where the angular velocity components of the inertial information are a set of data on three axes of pan, tilt, and roll, for each frame of 30 fps, but the disclosure is not limited thereto. For example, high-frequency data of 300 Hz or the like may be used. Combining data of 300 Hz makes it possible to create angular velocity data at 30 Hz.

In the present exemplary embodiment, the example is used where the blur threshold for determining whether the accumulated blur is the low accumulated blur is calculated based on the shutter speed, but the disclosure is not limited thereto, and a fixed value determined in advance may be used. For example, blur amounts of all frames included in one moving image sequence or a specific time range in a moving image sequence may be calculated, the calculated blur amounts of the frames may be sorted in ascending order, and the blur amount of the frame that is at a predetermined percentage on a higher side relative to all the frames may be set as the blur threshold. Alternatively, the blur amounts of the frames may be sorted in the ascending order, and the blur amount of the frame that is at a predetermined ordinal number on the higher side relative to all the frames may be set as the blur threshold. The frame that is at a predetermined percentage on the higher side in the ascending order of the blur amounts may be a frame that is at the top 0.1% on the higher side relative to all the frames, for example. In these examples, it can also be said that the processing of the flowchart in FIG. 3 is performed using, as the blur threshold, the blur amount of the frame that is at the top 0.1% on the higher side in the ascending order of the blur amounts relative to all the frames, or the blur amount of the frame that is at a predetermined ordinal number on the higher side. This also includes selecting one frame with the smallest blur amount from among the frames included in one moving image sequence or a specific time range in one moving image sequence. Furthermore, the blur amount of the frame that is at the top 0.1% on the higher side in the ascending order of the blur amounts, or the blur amount of the frame that is at a predetermined ordinal number on the higher side may be recorded as the threshold in the metadata. The range does not need to be continuous, and a plurality of discontinuous sections in a sequence may be combined to be regarded as a range, and a frame with the smallest blur amount or a higher-side frame with a smaller blur amount may be selected and recorded as metadata.

In the present exemplary embodiment, the blur amount m is calculated taking into account all three components of pan direction, tilt direction, and roll direction, but the disclosure is not limited thereto. In general camerawork, there is motion in the pan direction and tilt direction, but camerawork in the roll direction is not performed in many cases. Thus, in one embodiment, the blur amount m may be calculated only from the angular velocity component p in the pan direction and the angular velocity component t in the tilt direction as in the following formula (3):

$$m = √ ( {p}^{2} + {t}^{2} ) \qquad ( 3 )$$

In the present exemplary embodiment, the blur amount is calculated using only the information detected by the gyro sensor among the information detected by the gyro sensor, the information detected by the acceleration sensor, and the information detected by the geomagnetic sensor included in the inertial information, but the disclosure is not limited thereto. The blur amount may be calculated by using the information detected by the gyro sensor in combination with acceleration information that is the information detected by the acceleration sensor, and geomagnetic information that is information detected by the geomagnetic sensor. In other words, the inertial information does not necessarily need to include these three pieces of information, and may include only the information detected by the gyro sensor, for example. In addition, the camera 101 may obtain information on the blur amount as one piece of inertial information, and add the information on the blur amount to the image as metadata so that the information on the blur amount is included in the inertial information. In this case, in step S303, the blur amount acquisition unit 123 illustrated in FIG. 1B does not calculate the blur amount but acquires the blur amount embedded in the inertial information.

In the first exemplary embodiment described above, the example is described where images of frames with the low accumulated blur are specified from among frames of a moving image. In comparison, in a second exemplary embodiment, images are specified from a moving image in consideration of not only the accumulated blur but also the defocused state caused by an out-of-focus state of the subject. In the second exemplary embodiment, an example is described where a frame in which the amount of defocus caused by an out-of-focus state of the subject is less than a predetermined defocus threshold (hereinafter, referred to as a less defocused frame) is further specified from among frames in which the amount of accumulated blur is less than a blur threshold, and a list of the specified frames is generated. In the second exemplary embodiment, the system configuration, the configuration of an information processing apparatus 102, and the like are identical to those illustrated in FIG. 1, and thus illustration and description thereof will be omitted. Hereinafter, a configuration and processing different from those in the first exemplary embodiment will be mainly described.

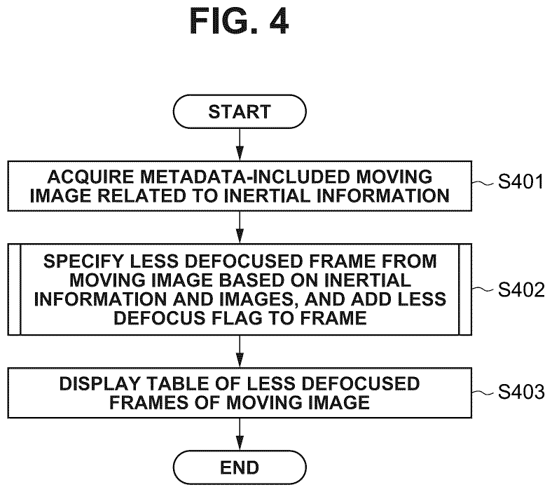

FIG. 4 is a flowchart illustrating a general procedure of information processing for specifying and displaying, in tabular form, a less defocused frame among frames in which the amount of accumulated blur is less than a blur threshold, among frames of a moving image, performed by the information processing apparatus 102 according to the second exemplary embodiment. The information processing in the flowchart illustrated in FIG. 4 is also executed by the functional components of the CPU 115 of the information processing apparatus 102 illustrated in FIG. 1B, as in the first exemplary embodiment.

First, in step S401, as in the first exemplary embodiment described above, an image acquisition unit 121 acquires a metadata-included image, and an inertial information acquisition unit 122 acquires the inertial information included in metadata from the metadata-included image.

In step S402, as in the first exemplary embodiment described above, a blur amount acquisition unit 123 acquires information indicating the amount of accumulated blur of the image of each frame of the moving image, based on the inertial information acquired in step S401. Further, in step S402, a determination unit 124 determines whether the amount of accumulated blur of the image of each frame of the moving image is less than a predetermined blur threshold. Then, as in the first exemplary embodiment, a listing unit 125 specifies frames of the moving image with low accumulated blur in which the amounts of accumulated blur have been determined as being less than the blur threshold, and generates an image list of identification information for identifying the specified frames.

In the second exemplary embodiment, the determination unit 124 analyzes the images of the frames with the low accumulated blur to obtain the amounts of defocus, specifies a less defocused frame in which the amount of defocus is less than a predetermined defocus threshold, and adds a less defocus flag to the less defocused frame. Details of the processing in step S402 will be described below.

In step S403, the table generation unit 126 generates a table of thumbnail images based on the image list generated in step S402. In the second exemplary embodiment, the table generation unit 126 can also generate a table of frames to each of which the less defocus flag has been added in step S402. Then, the data on these tables is sent to the GPU 113. The GPU 113 generates display data for the tables and displays the display data on the screen of the display 103. More specifically, in the second exemplary embodiment, not only a table of thumbnail images of frames with the low accumulated blur, but also a table of thumbnail images of less defocused frames can be displayed on the screen of the display 103.

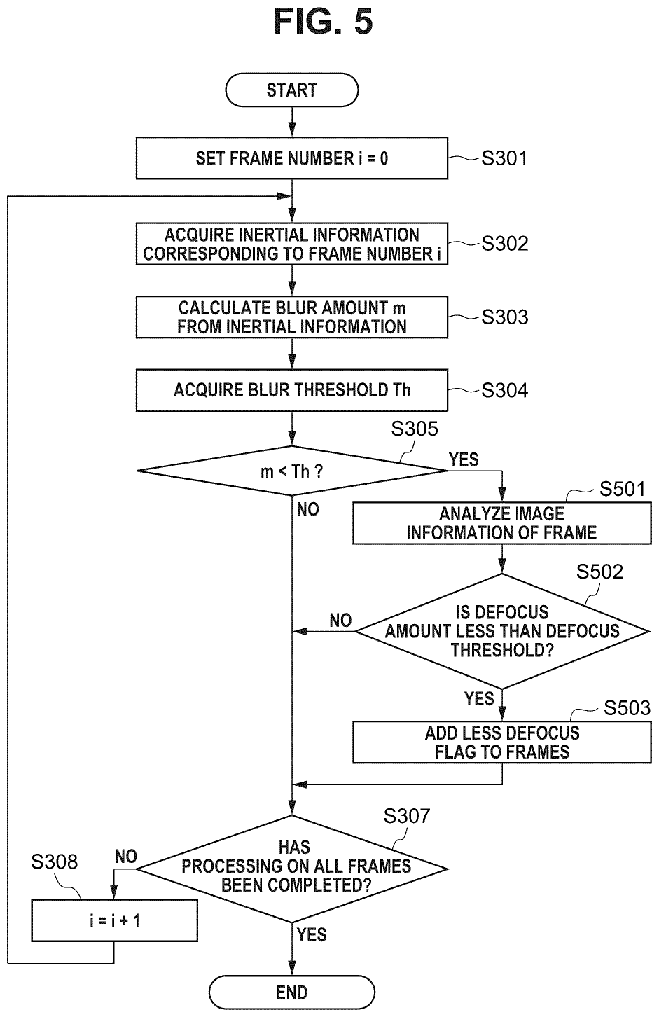

FIG. 5 is a flowchart of the processing in step S402 in FIG. 4. In the flowchart in FIG. 5, steps S301 to S305, S307, and S308 are similar to the corresponding steps in FIG. 3, and thus description thereof will be omitted. In the flowchart in FIG. 5, if it is determined in step S305 that the blur amount m is less than the blur threshold Th (YES in step S305), the processing proceeds to step S501.

If the processing proceeds to step S501, the listing unit 125 adds a frame number i with which the blur amount m is less than the blur threshold Th to the image list, as in the first exemplary embodiment described above. Furthermore, in the second exemplary embodiment, in step S501, the determination unit 124 analyzes image information of a frame in which the blur amount m has been determined as being less than the blur threshold Th in step S305, and obtains the amount of defocus (defocus amount) of the image. The method for a process of obtaining the defocus amount by analyzing the image information of the frame in step S501 is not particularly limited, and any of various known methods may be used, such as the method discussed in Japanese Patent Application Laid-Open No. 2013-26937.

In step S502, the determination unit 124 determines whether the defocus amount obtained by analyzing the image information in step S501 is less than the defocus threshold. If the determination unit 124 determines that the defocus amount is less than the defocus threshold (YES in step S502), the processing proceeds to step S503, and if the determination unit 124 determines that the defocus amount is equal to or greater than the defocus threshold (NO in step S502), the processing proceeds to step S307.

When the defocus amount is determined as being less than the defocus threshold and the processing proceeds to step S503, the determination unit 124 adds a less defocus flag to each frame in the above-described image list in which the defocus amount has been determined as being less than the defocus threshold, i.e., to less defocused frames. In the second exemplary embodiment, for the less defocused frames in which the defocus amounts are less than the defocus threshold, the Boolean variable indicating whether the accumulated blur is the low accumulated blur is set to true. In other words, for the less defocused frames in which the defocus amounts are determined as being equal to or greater than the defocus threshold, the Boolean variable is set to false, which indicates that the accumulated blur is large. These pieces of information are managed in a memory by the listing unit 125 and are referred to when the table generation unit 126 executes the processing in step S403 in FIG. 4.

More specifically, in the second exemplary embodiment, the table generation unit 126 can display not only the table of thumbnail images of frames with the low accumulated blur, but also the table of thumbnail images of frames in which the amount of defocus that is caused by the out-of-focus state of the subject or the like is small, by referring to the less defocus flag.

In the second exemplary embodiment, as described above, the information processing apparatus 102 does not analyze images of all frames of a moving image, but analyzes image information of only frames that are specified as having the low accumulated blur based on the inertial information, and specifies less defocused frames based on analysis results. Therefore, in the second exemplary embodiment, it is possible to specify the less defocused frames from among the frames of the moving image and display the frames in tabular form in a very short processing time, as compared to the case where the images of all the frames of the moving image are analyzed.

In the second exemplary embodiment, in step S501, the frame number i of the frame in which the blur amount m is less than the blur threshold Th is added to the image list as in the first exemplary embodiment, but this processing may not be performed. In such a case, in step S501, the determination unit 124 analyzes the image information of the frame in which the blur amount m is less than the blur threshold Th. Then, in step S503, the determination unit 124 adds the less defocus flag to the less defocused frame in which the defocus amount has been determined as being less than the defocus threshold in step S502. In this case, in step S503, the listing unit 125 adds the frame number i of the less defocused frame to which the less defocus flag has been added, to the image list. In other words, in this case, the image list is a list in which the less defocused frames can be identified. This makes it possible to display the table of only thumbnail images of the less defocused frames.

In the second exemplary embodiment, the example where the processing of analyzing image information and the processing of determining whether the defocus amount is small are performed is described. However, if only the less defocus flag is to be generated, the processing of image information analysis and the processing of determining the defocus amount may be omitted. In a case where the analysis processing and the determination processing are not performed, the less defocus flag will be a flag indicating that there is little motion blur (i.e., accumulated blur), as in the first exemplary embodiment. In other words, the image list of frames with small defocus amounts can be generated by adding an image analysis processing step and a determination processing step to the processing in the flowchart of FIG. 3 in the first exemplary embodiment.

In the first and second exemplary embodiments, the example where the CPU 115 executes the information processing program to perform the processing of each processing step is described, but the disclosure is not limited to the example. The information processing apparatus 102 may include dedicated hardware components for performing the processing, and the hardware components may perform the processing.

In the second exemplary embodiment, the CPU 115 (listing unit 125) is described as managing the less defocus flag in the memory. Alternatively, the less defocus flag itself may be added as metadata of an image and recorded on a recording medium, such as a memory card. More specifically, if the less defocus flag is added to the metadata of the image, when the moving image is read from a memory card for the second time, for example, it is possible to specify the image of the less defocused frame without calculating blur amounts or performing image analysis again.

The calculated blur amount of each frame and the threshold may be recorded on a memory card, for example. In this case, if the blur amount is determined using the threshold recorded on the memory card, it is possible to obtain a result equivalent to that obtained by determining whether a defocused state is present using a flag.

In the first and second exemplary embodiments described above, the example where the inertial information included in the metadata is acquired to perform the above-described information processing in the information processing apparatus 102 is described. However, the aspect of the embodiments is not limited to this example, and information processing identical to the one described above may be performed in the camera 101. In such a case, a flag indicating a low accumulated blur or a less defocus flag may be added as metadata for each frame and recorded on the memory card, separately from the inertial information. This allows the information processing apparatus 102 to refer to the flag indicating a low accumulated blur or the less defocus flag added as metadata to specify a frame with the low accumulated blur or a frame with a small defocus amount and display the frame in tabular form.

The present disclosure can be realized by processing of supplying a program for implementing one or more of the functions of the above-described exemplary embodiments to a system or device via a network or storage medium, and reading and executing the program by one or more processors in a computer of the system or device. The present disclosure can also be realized by a circuit (for example, an application specific integrated circuit (ASIC)) that implements the one or more of the functions of the above-described exemplary embodiments. The above-described exemplary embodiments are merely examples of implementations of the present disclosure, and the technical scope of the present disclosure should not be interpreted as being limited by these exemplary embodiments. In other words, the present disclosure can be implemented in various forms without departing from its technical concept or main features.

According to the present disclosure, it is possible to specify an image with a small defocus amount from among a plurality of images without taking a lot of time on processing.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-196527, filed Nov. 20, 2023, which is hereby incorporated by reference herein in its entirety.

What is claimed is:

1. A processing apparatus comprising:
an acquisition unit configured to acquire inertial information of an imaging apparatus from an image acquired at a time of imaging and to which the inertial information is added; and
a specification unit configured to specify, based on the inertial information, an image in which a blur amount of the imaging apparatus at the time of imaging is less than a threshold.

2. The processing apparatus according to claim 1, further comprising an analysis unit configured to analyze a defocus amount of an image,
wherein the analysis unit performs analysis on the image in which the blur amount is less than the threshold.

3. The processing apparatus according to claim 2, wherein the specification unit specifies an image in which the defocus amount analyzed by the analysis unit is less than a defocus threshold.

4. The processing apparatus according to claim 2, wherein the specification unit specifies the image in which the blur amount is less than the threshold and an image in which the defocus amount analyzed by the analysis unit is less than a defocus threshold.

5. The processing apparatus according to claim 1, wherein the specification unit generates identification information for identifying the specified image.

6. The processing apparatus according to claim 5, wherein the specification unit generates a list of the specified image by using the identification information.

7. The processing apparatus according to claim 6, wherein the specification unit generates a table of images based on the list.

8. The processing apparatus according to claim 1, wherein the specification unit sets the threshold based on a shutter speed of the imaging apparatus at the time of imaging.

9. The processing apparatus according to claim 1, wherein, when blur amounts of a plurality of images to which the inertial information is added are sorted in ascending order, the specification unit sets, as the threshold, a blur amount of an image at a predetermined percentage on a higher side in the ascending order, or a blur amount of an image at a predetermined ordinal number in the higher side in the ascending order.

10. The processing apparatus according to claim 2, further comprising a unit configured to add a predetermined flag to the image in which the defocus amount is less than the defocus threshold and record the image on a recording medium.

11. The processing apparatus according to claim 4, further comprising a unit configured to add a predetermined flag to the image in which the defocus amount is less than the defocus threshold and record the image on a recording medium.

12. The processing apparatus according to claim 1, wherein the inertial information is information detected by an inertial sensor included in the imaging apparatus.

13. The processing apparatus according to claim 1, wherein the image is an image of each frame constituting a moving image, or an image among a plurality of still images captured in succession.

14. A processing method comprising:
acquiring inertial information of an imaging apparatus from an image acquired at a time of imaging and to which the inertial information is added; and
specifying, based on the inertial information, an image in which a blur amount of the imaging apparatus at the time of imaging is less than a threshold.

15. The processing method according to claim 14, further comprising analyzing a defocus amount of an image,
wherein the analyzing performs analysis on the image in which the blur amount is less than the threshold.

16. The processing method according to claim 14, wherein, when blur amounts of a plurality of images to which the inertial information is added are sorted in ascending order, the specifying sets, as the threshold, a blur amount of an image at a predetermined percentage on a higher side in the ascending order, or a blur amount of an image at a predetermined ordinal number in the higher side in the ascending order.

17. A non-transitory computer-readable storage medium storing instructions that, when executed by a computer, cause the computer to perform a method comprising:
acquiring inertial information of an imaging apparatus from an image acquired at a time of imaging and to which the inertial information is added; and
specifying, based on the inertial information, an image in which a blur amount of the imaging apparatus at the time of imaging is less than a threshold.

18. The non-transitory computer-readable storage medium according to claim 17, further comprising analyzing a defocus amount of an image,
wherein the analyzing performs analysis on the image in which the blur amount is less than the threshold.

19. The non-transitory computer-readable storage medium according to claim 17, wherein, when blur amounts of a plurality of images to which the inertial information is added are sorted in ascending order, the specifying sets, as the threshold, a blur amount of an image at a predetermined percentage on a higher side in the ascending order, or a blur amount of an image at a predetermined ordinal number in the higher side in the ascending order.
